(19) United States
(12) Patent Application Publication
(10) Pub. No.: US 2017/0132626 A1
(43) Pub. Date: May 11, 2017

(54) METHOD AND SYSTEM FOR PROCESSING OF A BLOCKCHAIN TRANSACTION IN A TRANSACTION PROCESSING NETWORK

(71) Applicant: MasterCard International Incorporated, Purchase, NY (US)

(72) Inventor: Dennis M. KENNEDY, St. Louis, MO (US)

(73) Assignee: MasterCard International Incorporated, Purchase, NY (US)

(21) Appl. No.: 14/933,572

(22) Filed: Nov. 5, 2015

(51) Int. Cl. G06Q 20/40

(52) U.S. Cl. CPC G06Q 20/401

(57) ABSTRACT

A method for validating blockchain transactions using a transaction processing network includes: storing one or more authentication rules configured to authenticate an electronic transaction and one or more verification rules configured to verify a blockchain transaction; receiving a transaction message including a message type indicator and a plurality of data elements including at least first data elements configured to store blockchain data and additional data elements configured to store transaction data values; identifying an authentication score based on application of at least one or more authentication rules to the transaction data values; identifying a verification score based on application of one or more verification rules to the blockchain data; generating a data message, the data message including the blockchain data stored in the first data elements, the identified authentication score, and the identified verification score; and electronically transmitting the generated data message to a blockchain network.

### FIELD

The present disclosure relates to the use of a blockchain in conjunction with a transaction processing network, specifically the posting of transaction message data in a blockchain verified using a transaction processing network and the verification and transmission of blockchain transaction data using a transaction processing network.

### BACKGROUND

Transaction processing networks, also known as payment networks, involve significant hardware and infrastructure that are specifically configured to quickly process payment transactions from anywhere in the world using a vast, interconnected network. Transaction processing networks often operate using detailed rules and standards, to ensure accuracy, security, efficiency, and otherwise maintain order in the processing of potentially trillions of transactions every year. While such networks are often highly sophisticated, transaction processors are often constantly developing new technologies to further increase the sophistication of these networks, to provide for even more security to protect against fraud and to provide peace of mind to consumers.

Thus, there is a need for a technical solution to further increase the security involved in the processing of payment transactions using a transaction processing network. The use of blockchains as an alternative for transaction processing has become more desirable in recent years, due to privacy and security concerns, where some consumers value the seemingly complete confidentiality and anonymity of blockchain transactions over an established, centralized processing network. The decentralized nature of a blockchain may be detrimental for a number of consumers, for example, such as due to the lack of security of digital wallets, the instability of blockchain currency, lack of processing speed, etc. However, it may be useful when used in conjunction with a transaction processing network to provide for added verification of traditionally processed transactions, and for increased performance and processing speed of blockchain transactions. Thus, there is a need for a technical solution where a payment transaction network may be used in conjunction with a blockchain network for increased processing of both types of transactions.

### SUMMARY

The present disclosure provides a description of systems and methods for validating blockchain transactions using a transaction processing network.

A method for validating blockchain transactions using a transaction processing network includes: storing, in a rules database of a processing server, a plurality of transaction rules including at least one or more authentication rules configured to authenticate an electronic transaction and one or more verification rules configured to verify a blockchain transaction; receiving, by a receiving device of the processing server, a transaction message, wherein the transaction message is associated with an electronic transaction, is formatted based on one or more standards, and includes at least a message type indicator indicative of a type of transaction and a plurality of data elements including at least one or more first data elements configured to store blockchain data and a plurality of additional data elements configured to store transaction data values; identifying, by an authentication module of the processing server, an authentication score for the electronic transaction based on application of at least one of the one or more authentication rules to the transaction data values stored in the plurality of additional data elements included in the received transaction message; identifying, by a verification module of the processing server, a verification score for the electronic transaction based on application of at least one of the one or more verification rules to the blockchain data stored in the one or more first data elements included in the received transaction message; generating, by a generation module of the processing server, a data message, wherein the data message includes at least the blockchain data stored in the one or more first data elements included in the received transaction message, the identified authentication score, and the identified verification score; and electronically transmitting, by a transmitting device of the processing server, the generated data message to a blockchain network associated with the blockchain data stored in the one or more first data elements included in the received transaction message.

A system for validating blockchain transactions using a transaction processing network includes: a rules database of a processing server configured to store a plurality of transaction rules including at least one or more authentication rules configured to authenticate an electronic transaction and one or more verification rules configured to verify a blockchain transaction; a receiving device of the processing server configured to receive a transaction message, wherein the transaction message is associated with an electronic transaction, is formatted based on one or more standards, and includes at least a message type indicator indicative of a type of transaction and a plurality of data elements including at least one or more first data elements configured to store blockchain data and a plurality of additional data elements configured to store transaction data values; an authentication module of the processing server configured to identify an authentication score for the electronic transaction based on application of at least one of the one or more authentication rules to the transaction data values stored in the plurality of additional data elements included in the received transaction message; a verification module of the processing server configured to identify a verification score for the electronic transaction based on application of at least one of the one or more verification rules to the blockchain data stored in the one or more first data elements included in the received transaction message; a generation module of the processing server configured to generate a data message, wherein the data message includes at least the blockchain data stored in the one or more first data elements included in the received transaction message, the identified authentication score, and the identified verification score; and a transmitting device of the processing server configured to electronically transmit the generated data message to a blockchain network associated with the blockchain data stored in the one or more first data elements included in the received transaction message.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for validating electronic payment transactions and blockchain transactions via usage of both blockchain networks and transaction processing networks in accordance with exemplary embodiments.

FIG. 2 is a block diagram illustrating the processing server of FIG. 1 for the validation of blockchain transactions and electronic payment transactions in accordance with exemplary embodiments.

FIG. 3 is a flow diagram illustrating a process for validating an electronic transaction using a private blockchain using the system of FIG. 1 in accordance with exemplary embodiments.

FIG. 4 is a flow diagram illustrating a process for validating a blockchain transaction using a transaction processing network using in the system of FIG. 1 in accordance with exemplary embodiments.

FIG. 5 is a flow chart illustrating an exemplary method for validating electronic transactions using a private blockchain in accordance with exemplary embodiments.

FIG. 6 is a flow chart illustrating an exemplary method for validating blockchain transactions using a transaction processing network in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks, also referred to herein as transaction processing networks, may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” or “transaction processing network” herein may refer to both the payment network as an entity, and the physical payment network, such as the equipment, hardware, and software comprising the payment network.

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, additional information may be captured, such as a source address, timestamp, etc. In some embodiments, a blockchain may also consist of additional, and in some instances arbitrary, data that is confirmed and validated by the blockchain network through proof of work and/or any other suitable verification techniques associated therewith. In some cases, such data may be included in the blockchain as part of transactions, such as included in additional data appended to transaction data. In some instances, the inclusion of such data in a blockchain may constitute a transaction. In such instances, a blockchain may not be directly associated with a specific digital, virtual, fiat, or other type of currency.

### System for Validation of Transactions Via Blockchain and Transaction Processing Networks

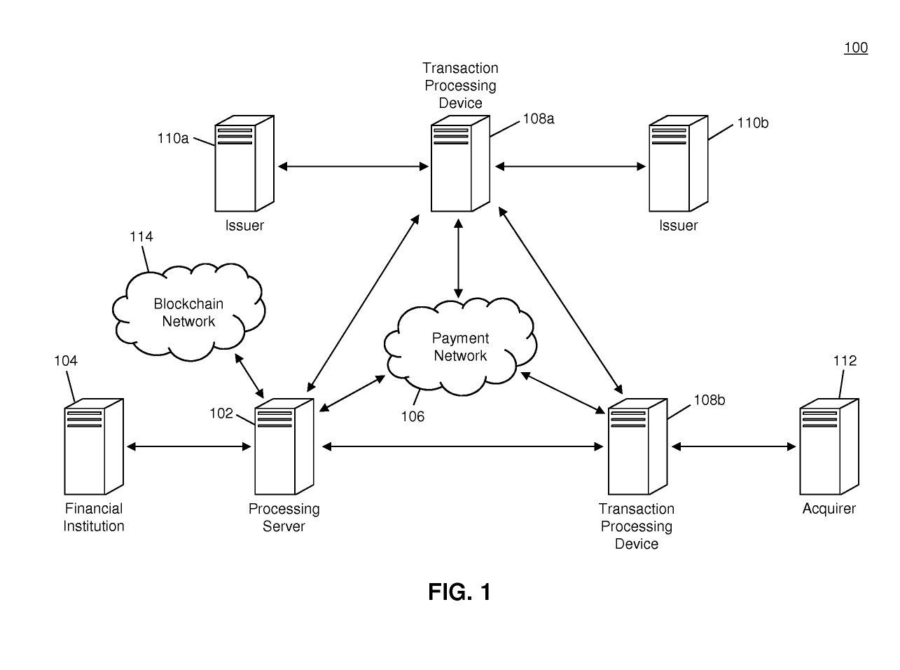

FIG. 1 illustrates a system 100 for the validation of electronic payment transactions via assistance of a blockchain network with a transaction processing network, as well as the validation of blockchain transactions via assistance of the transaction processing network with the blockchain network.

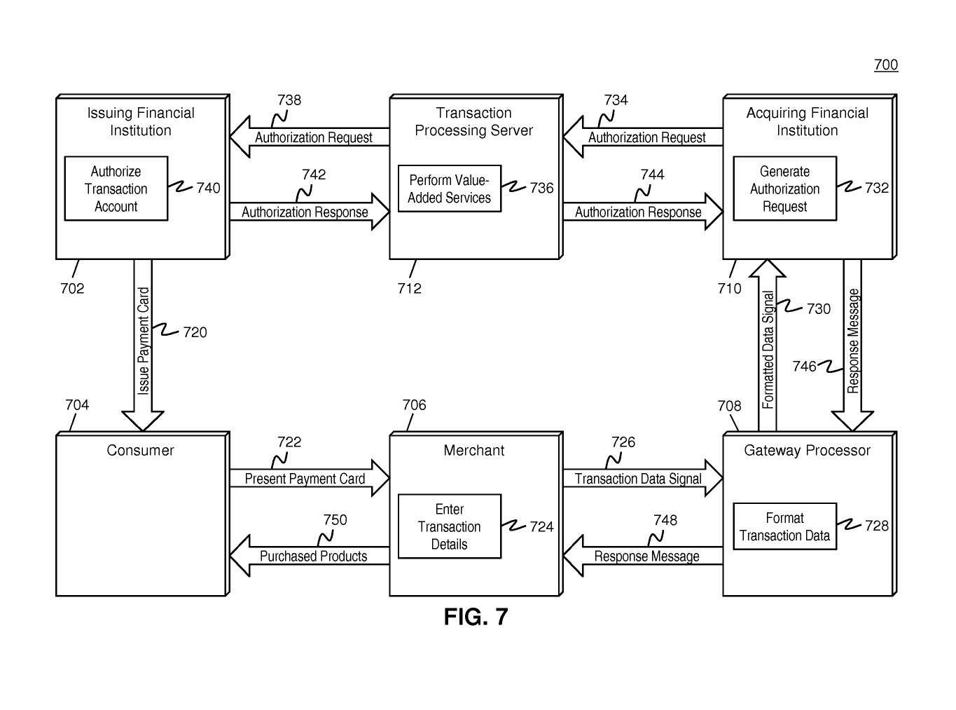

The system 100 may include a processing server 102. The processing server 102, discussed in detail below, may be configured to assist in the validation of both electronic payment transactions processed using a payment network 106 and blockchain transactions associated with a blockchain network 114. The processing server 102 may be part of a computing system of the payment network 106 or may be external to the payment network 106 but configured to communicate with the payment network 106 using the payment rails, which herein may refer to infrastructure associated with the payment network 106 used in the processing of payment transactions and the communication of transaction messages and other similar data between the payment network 106 and other entities interconnected with the payment network, such as the processing server 102. The payment rails may be comprised of the hardware used to establish the payment network and the interconnections between the payment network and other associated entities, such as financial institutions, gateway processors, etc. In some instances, the processing server 102 may be a transaction processing device 108, which may be a computing device associated with the payment network 106 used in the processing of electronic payment transactions using traditional methods. Additional detail regarding payment networks 106 and transaction processing devices 108 is discussed below with respect to the process 700 illustrated in FIG. 7.

The processing server 102 may be configured to communicate with a financial institution 104. In some instances, the processing server 102 may be a part of a computing system of the financial institution 104. In other instances, the processing server 102 may communicate with the financial institution 104 using a suitable communication network, such as the Internet, a local area network, a wireless area network, a radio frequency network, etc. The financial institution 104 may be an entity involved in the conducting and processing of payment transactions, such as a participant (e.g., payer or payee), an account holder, gateway processor, etc. In some cases, the financial institution 104 may be an issuer 110, which may be a financial institution, such as an issuing bank, that issues a transaction account used to fund a payment transaction. In other cases, the financial institution 104 may be an acquirer 112, which may be a financial institution, such as an acquiring bank, that issues a transaction account used to receive funds in a payment transaction. In some instances, a financial institution 104 may be both an issuer 110 and acquirer 112, and, in some cases, may participate in a transaction as both issuer 110 and acquirer 112. As illustrated in FIG. 1, each processing server 102 and transaction processing device 108 may be configured to communicate with one or more financial institutions 104, issues 110, acquirers 112, and other entities involved in the processing of electronic payment and blockchain transactions.

In some embodiments, the processing server 102 may be a node in the blockchain network 114. As a node in the blockchain network 114, the processing server 102 may be configured to post blockchain transactions to a blockchain associated with the blockchain network 114, and may also be configured to validate transactions posted to the blockchain. Methods for validating transactions posted to a blockchain will be apparent to persons having skill in the relevant art, and may include, for example, proof of work calculations and confirmations. In some instances, transaction processing devices 108 may be configured as nodes for a blockchain network 114. In some embodiments, the processing server 102 and one or more transaction processing devices 108 may comprise a blockchain network 114. Such a blockchain network 114 may be herein referred to as a “private” blockchain network 114 or “trusted” blockchain network and may be associated with a “private” or “trusted” blockchain. In some cases, a processing server 102 may be a priority node in a blockchain network 114 such that transactions posted to the blockchain from the processing server 102 may be verified with a higher priority or may be considered pre-verified by the processing server 102 for faster adding to the associated blockchain as a result of the processes discussed herein.

In some instances, the processing server 102 may be configured to validate electronic payment transactions processed via the payment network 106 via the use of a private blockchain associated with a blockchain network 114 such as may include the processing server 102 and transaction processing devices 108. As used herein, “private” blockchain may refer to a blockchain that is not publicly accessible such that only authorized computing devices and/or systems may be configured to post transactions to the blockchain.

In a traditional electronic payment transaction, an acquirer 112 associated with a merchant involved in the payment transaction may submit a transaction message to the payment network 106 via a transaction processing device 108. The transaction message may be a specially formatted data message that is formatted based on one or more standards governing the exchange of financial transaction messages, such as the International Organization of Standardization's ISO 8583 standard. Transaction messages may include a plurality of data elements configured to store data as set forth in the associated standard, such as data elements configured to store a primary account number used to fund the payment transaction, a transaction amount, a geographic location, a merchant identifier, an acquirer identifier, an issuer identifier, financial institution data, currency data, point of sale data, and other data associated with the payment transaction that may be useful in the processing thereof. In some instances, a transaction message may also include a message type indicator, which may be indicative of a type for the transaction message. For example, the message type indicator may indicate the transaction message as an authorization request, authorization response, clearing record, settlement request, settlement record, etc.

The transaction message may be electronically transmitted by the acquirer 112 to the transaction processing device 108 and then to the payment network 106 using the payment rails or a suitable alternative communication network configured for the secure transmission of transaction messages. The payment network 106 or transaction processing device 108 may be configured to forward the transaction message to the processing server 102 for enhanced validation using the private blockchain. In some instances, the transaction message may be forwarded to the processing server 102 prior to traditional processing of the payment transaction using the payment network 106. In other instances, the payment transaction may be processed (e.g., approved by an associated issuer 110 and an authorization response returned to the acquirer 112) prior to forwarding of the transaction message to the processing server 102.

The processing server 102 may receive the transaction message, which may include a plurality of data elements each configured to store a transaction data value associated with the related payment transaction. The processing server 102 may be configured to generate a data record, which may correspond to a blockchain transaction to be posted to the private blockchain. The data record may include the message type indicator included in the transaction message as well as one or more of the transaction data values stored in the corresponding data elements in the transaction message. The data record may then be posted to the private blockchain by the processing server 102. The data record may be subsequently verified by one or more nodes included in the associated blockchain network 114, such as the transaction processing devices 108 comprising the blockchain network 114. The data record may then be a part of the blockchain, which may thus be independently verifiable by any entity configured to access the blockchain, such as the acquirer 112 and/or issuer 110 involved in the electronic payment transaction, a third party financial institution 104, a consumer or merchant involved in the electronic payment transaction, etc. The private blockchain may thus be used as a secure and confidential, yet publicly accessible, record of processed payment transactions for third party verification.

For example, the data record posted to the blockchain may include transaction data values that may be beneficial for use in additional verification of the associated electronic payment transaction, such as transaction amount, transaction time and/or date, geographic location, merchant name, etc. In some instances, the generated data record may not include transaction account numbers. In some cases, one or more transaction data values may be hashed, such that the values may be verified via the generated data record, without the underlying transaction data values being obtainable. For example, the primary account number associated with the transaction account used to fund the payment transaction may be hashed such that the payer may be verified using the hashed primary account number, but without the actual primary account number being obtainable via the data record posted to the private blockchain.

Along with being configured to use a private blockchain to validate a payment transaction processed using the payment network 106, the processing server 102 may also be configured to validate blockchain transactions posted to a blockchain associated with the blockchain network 114 via the payment network 106 and associated payment rails. In such embodiments, the processing server 102 may receive a transaction message via the payment rails from the payment network 106, a transaction processing device 108, a financial institution 104, the blockchain network 114, or other suitable entity. The transaction message may be formatted based on one or more standards, such as the ISO 8583 standard, and include a plurality of data elements configured to store data including transaction data values and blockchain data.

The blockchain data may be data associated with a blockchain transaction, such as a sender address, destination or recipient address, network identifier, a network address, a currency amount, etc. In some embodiments, each data value in the blockchain data may be stored in a separate data element in the received transaction message. In other embodiments, all of the blockchain data may be stored in a single data element. In some instances, data elements configured to store blockchain data may be reserved for private use as indicated in the associated formatting standards.

The processing server 102 may store a plurality of transaction rules for the verification and authentication of payment and blockchain transactions. The transaction rules may include authentication rules configured to authenticate transaction data values stored in corresponding data elements in a transaction message, as well as verification rules configured to verify blockchain data associated with a blockchain transaction. Upon receipt of the transaction message including the blockchain data, the processing server 102 may be configured to apply the authentication rules to the transaction data values stored therein and the verification rules to the blockchain data stored therein to generate authentication and verification scores, respectively. The authentication score may indicate a likelihood of fraud, such as based on a comparison of a merchant identifier to a geographic location, a transaction amount to a blockchain currency amount, etc. The verification score may indicate a likelihood of fraud for the blockchain transaction, such as based on the currency amount and the sender address (e.g., if the sender address has access to sufficient currency based on prior blockchain transactions).

The processing server 102 may generate a data message that includes the blockchain data from the transaction message as well as the identified authentication and verification scores, and may electronically transmit the data message to the blockchain network 114. The blockchain network 114 may evaluate the blockchain data for posting to the associated blockchain depending on the authentication and verification score. For example, the blockchain network 114 may have a threshold that the verification score and/or authentication score must exceed to proceed with posting the blockchain data to the blockchain as a new transaction. In some instances, the blockchain network 114 may have a separate threshold for the authentication score and the verification score. In some cases, one blockchain network 114 may have different thresholds from a different blockchain network 114, such as in instances where the processing server 102 may be configured to provide enhanced validation of blockchain transactions using the payment network 106 for more than one blockchain.

Methods and systems discussed herein enable the processing server 102 to provide additional validation of electronic payment transactions via the use of a private, trusted blockchain, as well as additional validation of blockchain transactions via the use of transaction messages electronically transmitted in a trusted payment network. The processing server 102 may therefore provide for enhanced validation of both electronic payment transactions and blockchain transactions, resulting in higher security for both types of transactions and decreased fraud, while protecting and maintaining a high level of consumer privacy.

### Processing Server

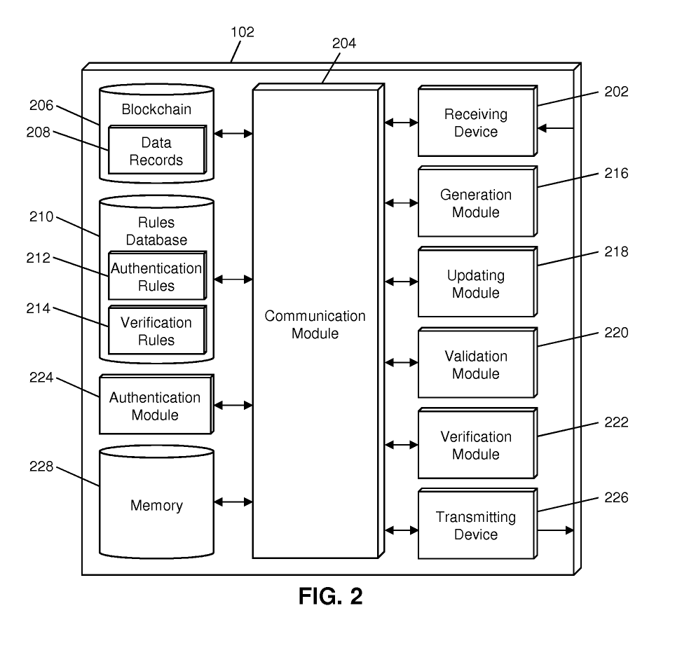

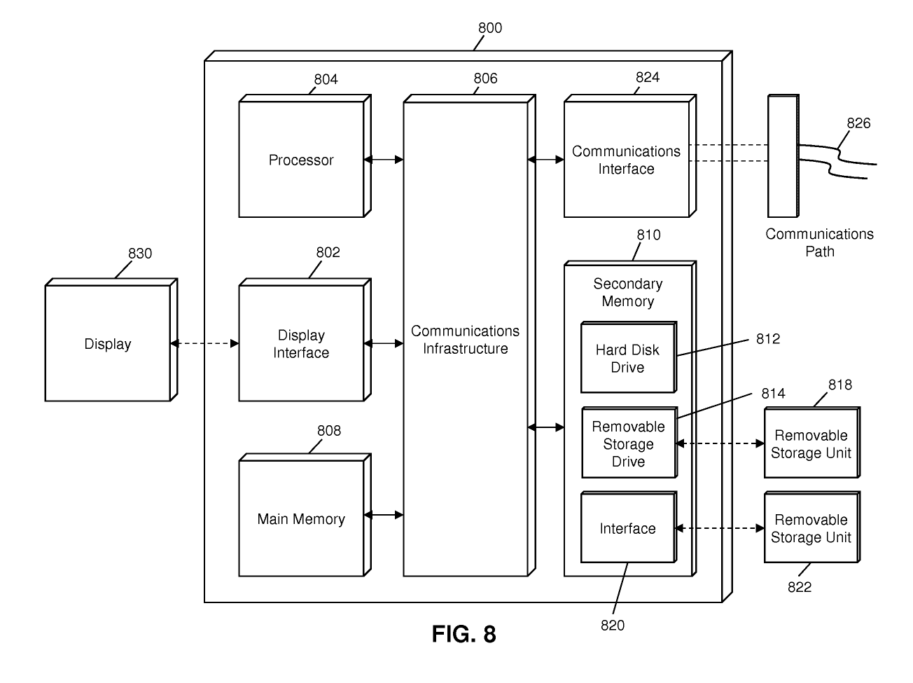

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 106 for the transmission of transaction messages that include sensitive financial data and information. In some instances, the receiving device 202 may also be configured to receive data from financial institutions 104, payment networks 106, transaction processing devices 108, issuers 110, acquirers 112, blockchain networks 114, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals from the transaction processing devices 108, payment networks 106, and financial institutions 104, which may be superimposed with transaction messages, and may also be electronically transmitted via the payment rails. The transaction messages may be formatted based on one or more standards, such as the ISO 8583 standard, and may include a plurality of data elements. Each data element may be configured to store transaction data values as set forth in the associated standard. In some instances, one or more data elements may also be configured to store blockchain data associated with a blockchain transaction. In some instances, a transaction message may also include a message type indicator, which may be indicative of a type of the transaction message, such as an authorization request or response, a clearing record, or a settlement record. The receiving device 202 may also be configured to receive blockchain data from a blockchain network 114. The blockchain data may comprise a blockchain and the associated data records included in the blockchain.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a generation module 216, updating module 218, validation module 220, verification module 222, authentication module 224, etc. As used herein, the term “module” may be software or hardware particularly programmed to receive an input, perform one or more processes using the input, and provide an output. The input, output, and processes performed by various modules will be apparent to one skilled in the art based upon the present disclosure.

In some embodiments, the processing server 102 may include a blockchain 206. The blockchain 206 may be configured to store a plurality of data records 208 using a suitable data storage format and schema. The blockchain 206 may be formatted in any suitable method, such as stored as a relational database that utilizes structured query language for the storage, identification, modifying, updating, accessing, etc. of structured data sets stored therein. Each data record 208 in the blockchain 206 may be associated with a blockchain transaction and include blockchain data associated therewith, such as a sender address, destination address, and currency amount.

The processing server 102 may also include a rules database 210. The rules database 210 may be configured to store a plurality of authentication rules 212 and verification rules 214 using a suitable data storage format and schema. In some instances, the rules database 210 may be a relational database that utilizes structured query language for the storage, identification, modifying, updating, accessing, etc. of structured data sets stored therein. The authentication rules 212 may be structured data sets that include rules that are applicable to transaction data values stored in data elements of a transaction message for the generation of an authentication score based thereon. The verification rules 214 may be structured data sets that include rules that are applicable to blockchain data for the generation of a verification score based thereon. The authentication score and verification score may be indicative of a likelihood of fraud or other value measured by the corresponding rules for the related payment transaction.

In some embodiments, the processing server 102 may include a querying module. The querying module may be configured to execute queries on databases to identify information. The querying module may receive one or more data values or query strings, and may execute a query string based thereon on an indicated database, such as the blockchain 206 or rules database 210, to identify information stored therein. The querying module may then output the identified information to an appropriate engine or module of the processing server 102 as necessary. The querying module may, for example, execute a query on the rules database 210 to identify authentication rules 212 and verification rules 214 to be applied to data stored in a received transaction message for scoring prior to forwarding of included blockchain data to an associated blockchain network 114.

The processing server 102 may also include an updating module 218. The updating module 218 may be configured to receive update data and an indication of data to be updated, and may be configured to update the indicated data accordingly. In some instances, the updating module 218 may utilize the querying module, such as by executing a query on a database that includes the date indicated for updating. For example, the updating module 218 may execute a query to update the blockchain 206 by adding one a data record 208 corresponding to a new blockchain transaction for which blockchain data is received (e.g., in a transaction message received by the receiving device 202). In some instances, the updating module 218 may output a notification to one or more modules of the processing server 102 indicating that the update process was completed.

The processing server 102 may also include a validation module 220. The validation module 220 may be configured to validate data received by the receiving device 202 and/or stored in the processing server 102. For example, the receiving device 202 may receive a new data record 208 to be updated in the blockchain 206 by the updating module 218. The validation module 220 may be configured to validate the new data record 208 using one or more suitable methods, such as a proof of work method associated with the corresponding blockchain 206. The validation module 220 may receive the data to be validated, may perform the appropriate validation methods, and may output an indication of success or failure for the validation. For example, if the validation of the new data record 208 is successful, the validation module 220 may indicate thusly, which may result in the adding of the new data record 208 to the blockchain 206 (e.g., by the updating module 218) and/or the transmission of a notification to the corresponding blockchain network 114 and/or one or more nodes in the corresponding blockchain network 114.

The processing server 102 may also include a verification module 222. The verification module 222 may be configured to calculate a verification score for a blockchain transaction. The verification module 222 may receive blockchain data as an input, and may be configured to calculate a verification score for the blockchain data via the application of one or more verification rules 214 to the blockchain data. In some instances, the verification rules 214 may be provided to the verification module 222 for use. In other instances, the verification module 222 may be configured to identify the verification rules 214 for use, such as based on the blockchain data. The resulting verification score may be output by the verification module 222 to a transmitting device 226 for transmission to a corresponding blockchain network 114.

The processing server 102 may also include an authentication module 224. The authentication module 224 may be configured to calculate an authentication score for an electronic payment transaction. The authentication module 224 may receive transaction data values as input, and may be configured to calculate an authentication score for the transaction data values via the application of one or more authentication rules 212 to the transaction data values. In some instances, the authentication rules 212 may be provided to the authentication module 224 for use. In other instances, the authentication module 224 may be configured to identify the authentication rules 212 for use, such as based on the transaction data values. The resulting authentication score may be output by the authentication module 224 to the transmitting device 226 for transmission to a corresponding blockchain network 114.

The transmitting device 226 may be configured to transmit data over one or more networks via one or more network protocols. In some embodiments, the transmitting device 226 may be configured to transmit data over the payment rails, such as using specially configured infrastructure associated with payment networks 106 for the transmission of transaction messages that include sensitive financial data and information, such as identified payment credentials. In some instances, the transmitting device 226 may be configured to transmit data to financial institutions 104, payment networks 106, transaction processing devices 108, issuers 110, acquirers 112, blockchain networks 114, and other entities via alternative networks, such as the Internet. In some embodiments, the transmitting device 226 may be comprised of multiple devices, such as different transmitting devices for transmitting data over different networks, such as a first transmitting device for transmitting data over the payment rails and a second transmitting device for transmitting data over the Internet. The transmitting device 226 may electronically transmit data signals that have data superimposed that may be parsed by a receiving computing device. In some instances, the transmitting device 226 may include one or more modules for superimposing, encoding, or otherwise formatting data into data signals suitable for transmission.

The transmitting device 226 may be configured to electronically transmit data signals to blockchain networks 114 for the posting of new blockchain transactions to the blockchain network 114. The data may include authentication and verification scores calculated by the authentication module 224 and verification module 222, respectively, as well as blockchain data stored in data element(s) included in a transaction message received by the receiving device 202. In some instances, the transmitting device 226 may be configured to electronically transmit data to multiple blockchain networks 114. In such instances, a blockchain network 114 may be identified for transmission based on a network identifier associated with the blockchain network 114 included in the blockchain data. The transmitting device 226 may also be configured to transmit validation data to a blockchain network 114 and to nodes (e.g., transaction processing devices 108) associated with a blockchain network 114, such as for newly added data records 208.

The processing server 102 may also include a memory 228. The memory 228 may be configured to store data for use by the processing server 102 in performing the functions discussed herein. The memory 228 may be configured to store data using suitable data formatting methods and schema and may be any suitable type of memory, such as read-only memory, random access memory, etc. The memory 228 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Process for Validating Payment Transactions Via Private Blockchain

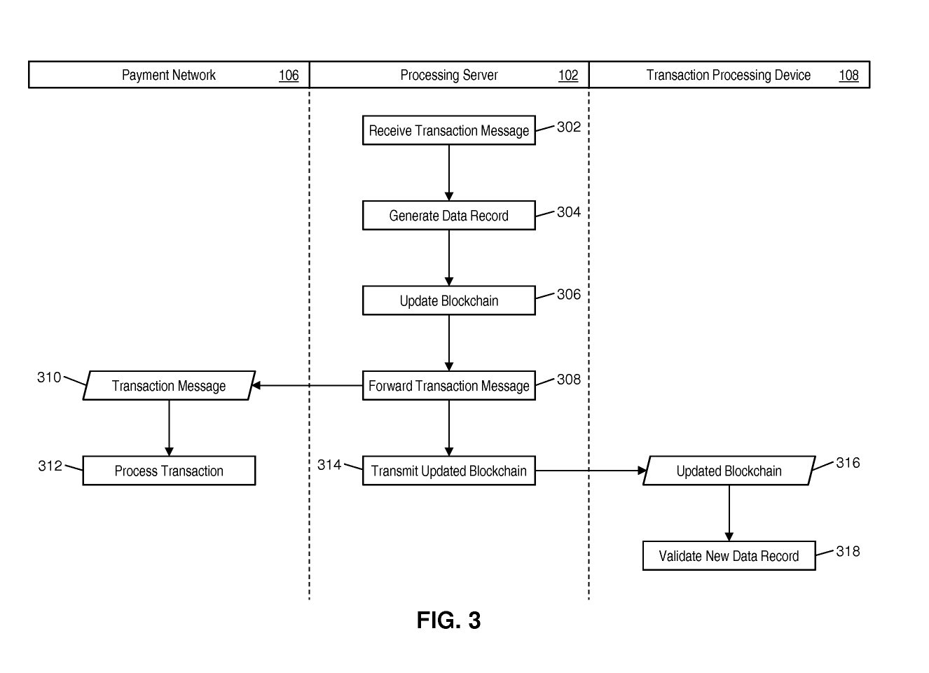

FIG. 3 illustrates a process for the validation of an electronic payment transaction via the use of a private blockchain.

In step 302, the receiving device 202 of the processing server 102 may receive a transaction message. The transaction message may be electronically transmitted to the processing server 102 via the payment network 106, and may be formatted based on one or more standards, such as the ISO 8583 standard, and include a plurality of data elements including at least data elements configured to store transaction data values for an electronic payment transaction. The data values may include, for example, transaction amount, transaction time, transaction data, geographic location, primary account number, consumer data, merchant data, issuer data, acquirer data, point of sale data, loyalty data, reward data, offer data, product data, etc. In some embodiments, the transaction message may also include a message type indicator indicative of an authorization request.

In step 304, the generation module 216 of the processing server 102 may generate a data record. The data record may be a data record suitable for inclusion in a private blockchain and include data suitable for use in validation of the related electronic payment transaction. The included data may comprise transaction data values stored in the data elements included in the transaction message. In some embodiments, one or more of the transaction data values included in the generated data record may be hashed and/or encrypted using one or more suitable hashing and encryption algorithms, respectively.

In step 306, the updating module 218 of the processing server 102 may update a private blockchain by adding the generated data record to the blockchain. In some instances, the private blockchain may be locally stored, such as the blockchain 206 locally stored in the processing server 102. In other instances, the private blockchain may be associated with a blockchain network 114, where the updating of the private blockchain may include the submission of the generated data record to the blockchain network 114 and/or one or more nodes associated therewith for verification and adding to the private blockchain.

In step 308, the transmitting device 226 of the processing server 102 may electronically transmit the transaction message to the payment network 106 for processing. In step 310, the payment network 106 may receive the transaction message and, in step 312, may process the related electronic payment transaction using the transaction message. The payment network 106 may utilize traditional methods for the processing of the payment transaction that will be apparent to persons having skill in the relevant art, such as the process 700 illustrated in FIG. 7 and discussed in more detail below.

In step 314, the transmitting device 226 of the processing server 102 may electronically transmit a data signal superimposed with the updated blockchain to a transaction processing device 108. In such an embodiment, the transaction processing device 108 may be a node in the blockchain network 114 associated with the private blockchain, which may include the processing server 102. In some instances, step 314 may include the transmitting of a notification to the transaction processing device 108 that the transaction has been posted to the private blockchain. In such instances, the notification may comprise one or more transaction data values suitable for use in identifying the new data record corresponding to the electronic payment transaction, such as a transaction identifier.

In step 316, the transaction processing device 108 may receive the updated private blockchain. In instances where the processing server 102 provides a notification of the updating of the private blockchain, step 316 may include the retrieval of the private blockchain from the blockchain network 114 using a suitable method. In step 318, the transaction processing device 108 may identify the generated data record that has been added to the private blockchain and may validate the electronic payment transaction. Validation of the electronic payment transaction may include confirmation transaction data values stored in the transaction message or a related transaction message, such as by confirming a transaction amount included in the data record with a transaction amount included in a clearing record. In some instances, the transaction processing device 108 may provide results of the validation, such as to the processing server 102 or to an entity involved in the electronic payment transaction.

### Process for Validating Blockchain Transactions Via Payment Networks

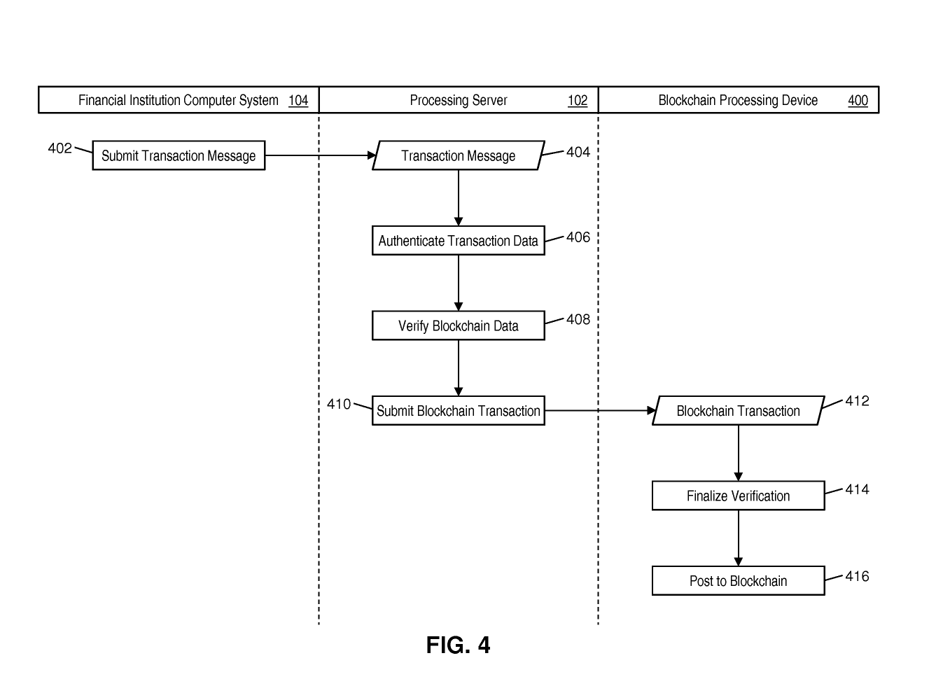

FIG. 4 illustrates a process for the validation of a blockchain transaction via the use of transaction messages electronically transmitted by a payment network 106 and data stored therein.

In step 402, the computer system for the financial institution 104 may submit a transaction message to the processing server 102. The financial institution 104 may be, for example, an acquirer 112 or a gateway processor configured to generate and submit an authorization request that includes data associated with a blockchain transaction to the processing server 102 for validation. In step 404, the receiving device 202 of the processing server 102 may receive the transaction message. The transaction message may be formatted based on one or more standards, such as the ISO 8583 standard, and include a plurality of data elements including at least one or more data elements configured to store blockchain data and one or more additional data elements configured to store transaction data values. The blockchain data may include, for example, a network identifier (e.g., associated with the blockchain network 114 associated with the blockchain to which the blockchain transaction is to be posted), a network address (e.g., for use in posting the blockchain transaction), a sender address, a destination address, a currency amount, and any other suitable data.

The transaction data values may include data values related to the blockchain transaction suitable for use in validating the blockchain transaction, such as a geographic location, transaction amount, consumer data, merchant data, etc. For example, the transaction data values may include a primary account number corresponding to a payer for the blockchain transaction for use in determining likelihood of fraud. In another example, the transaction data values may include a geographic location and may also include a merchant identifier associated with a payee for the blockchain transaction, where the geographic location may be used to identify if the merchant is genuine.

In step 406, the authentication module 224 of the processing server 102 may calculate an authentication score for the blockchain transaction. The authentication score may be calculated based on the application of one or more authentication rules 212 to the transaction data value stored in the corresponding data elements included in the transaction message. The authentication score may represent an indication of the likelihood of fraud for the related blockchain transaction based on the authentication rules 212 and the transaction data values. In step 408, the verification module 222 of the processing server 102 may calculate a verification score for the blockchain transaction. The verification score may be calculated based on the application of one or more verification rules 214 to the blockchain data stored in the corresponding one or more data elements included in the transaction message. The verification score may represent an indication of the likelihood of fraud for the related blockchain transaction based on the verification rules 214 and the transaction data values. For example, the verification rules may include verification that the sender address has access to the currency amount based on the data records in the associated blockchain.

In step 410, the transmitting device 226 of the processing server 102 may electronically transmit the blockchain data stored in the corresponding data element(s) in the transaction message, as well as the calculated authentication and verification scores, to a blockchain processing device 400. The blockchain processing device 400 may be a computing device and/or system associated with a blockchain network 114 to which the blockchain transaction is being submitted, which may be identified via a network identifier included in the blockchain data. The blockchain processing device 400 may be, for example, a transaction processing device 108 or other computing device configured to serve as a node for the blockchain network 114. In some instances, the processing server 102 may be configured to operate as a blockchain processing device 400 for one or more blockchain networks 114 and may perform the steps discussed herein.

In step 412, the blockchain processing device 400 may receive the blockchain data and the corresponding authentication and verification scores. In step 414, the blockchain processing device 400 may finalize verification of the blockchain transaction. The finalizing of verification may include determining if the transaction is to be approved or denied based on the authentication and verification scores and corresponding thresholds. In some instances, a threshold may be based on blockchain data. For example, a blockchain transaction with a higher currency amount may have a higher threshold due to an increase risk of fraud and/or an increased detriment incurred due to fraud. In some cases, the blockchain processing device 400 may perform additional verification steps as performed in traditional blockchain transactions as will be apparent to persons having skill in the relevant art. Once the transaction has been finally verified, then, in step 416, the blockchain processing device 400 may post the blockchain transaction to the blockchain for inclusion therein.

### Exemplary Method for Validating Electronic Transactions Using a Private Blockchain

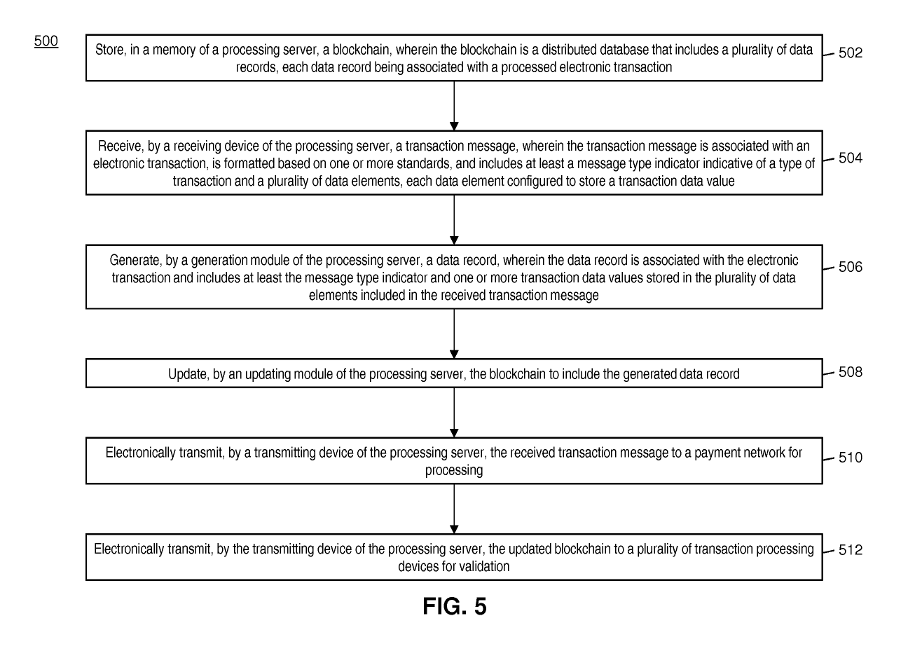

FIG. 5 illustrates a method 500 for the validation of an electronic payment transaction via the use of a private blockchain for the posting of data included therein.

In step 502, a blockchain (e.g., the blockchain 206) may be stored in a memory (e.g., the memory 228) of a processing server (e.g., the processing server 102), wherein the blockchain is a distributed database that includes a plurality of data records (e.g., data records 208), each data record being associated with a processed electronic transaction. In step 504, a transaction message may be received by a receiving device (e.g., the receiving device 202) of the processing server, wherein the transaction message is associated with an electronic transaction, is formatted based on one or more standards, and includes at least a message type indicator indicative of a type of transaction and a plurality of data elements, each data element configured to store a transaction data value.

In step 506, a data record may be generated by a generation module (e.g., the generation module 216) of the processing server, wherein the data record is associated with the electronic transaction and includes at least the message type indicator and one or more transaction data values stored in the plurality of data elements included in the received transaction message. In step 508, the blockchain may be updated by an updating module (e.g., the updating module 218) to include the generated data record.

In step 510, the received transaction message may be electronically transmitted by a transmitting device (e.g., the transmitting device 226) of the processing server to a payment network (e.g., the payment network 106) for processing. In step 512, the updated blockchain may be electronically transmitted by the transmitting device of the processing server to a plurality of transaction processing devices (e.g., transaction processing devices 108) for validation.

In one embodiment, the type of transaction may be one of: authorization, clearing, or settlement. In some embodiments, the one or more standards may include the ISO 8583 standard. In one embodiment, the generated data record may include the received transaction message. In some embodiments, the transaction data value may include one of: transaction amount, transaction time, transaction date, primary account number, merchant identifier, issuer identifier, acquirer identifier, processor identifier, and geographic location. In one embodiment, the processing server may be a transaction processing device associated with the payment network. In some embodiments, each of the plurality of transaction processing devices may be associated with the payment network.

In one embodiment, the method 500 may further include: receiving, by the receiving device of the processing server, a further updated blockchain from a transaction processing device, wherein the further updated blockchain includes the plurality of data records, the generated data record, and a new data record; and validating, by a validation module (e.g., the validation module 220) of the processing server, the new data record. In a further embodiment, the method 500 may even further include storing, in the memory of the processing server, one or more validation algorithms, wherein the new data record is validated based on application of the one or more validation algorithms to data included in the new data record. In another further embodiment, the method 500 may even further include electronically transmitting, by the transmitting device of the processing server, a data signal superimposed with a confirmation of validation of the new data record to the transaction processing device.

### Exemplary Method for Validating Blockchain Transactions Using a Transaction Processing Network

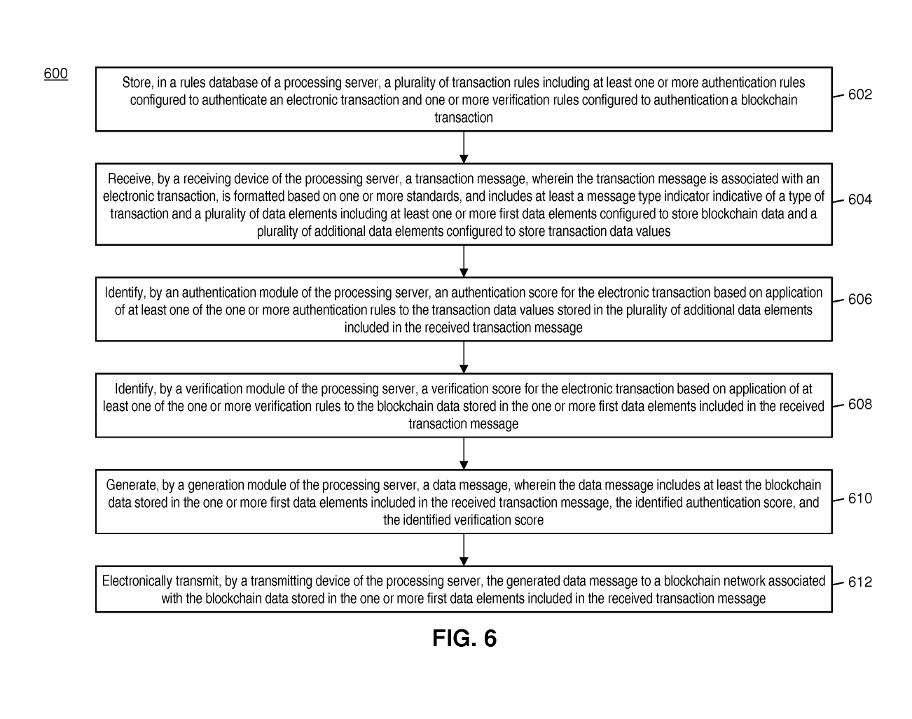

FIG. 6 illustrates a method 600 for the validation of a blockchain transaction using data conveyed in a transaction message using a transaction processing network.

In step 602, a plurality of transaction rules may be stored in a rules database (e.g., the rules database 210) of a processing server (e.g., the processing server 102), wherein the plurality of transaction rules includes at least one or more authentication rules (e.g., authentication rules 212) configured to authenticate an electronic transaction and one or more verification rules (e.g., verification rules 214) configured to verify a blockchain transaction. In step 604, a transaction message may be received by a receiving device (e.g., the receiving device 202) of the processing server, wherein the transaction message is associated with an electronic transaction, is formatted based on one or more standards, and includes at least a message type indicator indicative of a type of transaction and a plurality of data elements including at least one or more first data elements configured to store blockchain data and a plurality of additional data elements configured to store transaction data values.

In step 606, an authentication score for the electronic transaction may be identified by an authentication module (e.g., the authentication module 224) of the processing server based on application of at least one of the one or more authentication rules to the transaction data values stored in the plurality of additional data elements included in the received transaction message. In step 608, a verification score for the electronic transaction may be identified by a verification module (e.g., the verification module 222) of the processing server based on application of at least one of the one or more verification rules to the blockchain data stored in the one or more first data elements included in the received transaction message.

In step 610, a data message may be generated by a generation module (e.g., the generation module 216) of the processing server, wherein the data message includes at least the blockchain data stored in the one or more first data elements included in the received transaction message, the identified authentication score, and the identified verification score. In step 612, the generated data message may be electronically transmitted by a transmitting device (e.g., the transmitting device 226) of the processing server to a blockchain network (e.g., the blockchain network 114) associated with the blockchain data stored in the one or more first data elements included in the received transaction message.

In one embodiment, the blockchain data may include at least one of: a network identifier, a network address, a sender address, a recipient address, and a currency amount. In a further embodiment, the blockchain network may be associated with the network identifier included in the blockchain data. In some embodiments, the type of transaction may be an authorization request. In one embodiment, the one or more standards may include the ISO 8583 standard. In some embodiments, the transaction data values may include at least one of: transaction amount, transaction time, transaction date, primary account number, merchant identifier, issuer identifier, acquirer identifier, processor identifier, and geographic location.

In one embodiment, one of the plurality of additional data elements may include a transaction identifier and the generated data message may further include the transaction identifier. In some embodiments, the generated data message may be electronically transmitted via superimposed in an electronically transmitted data signal. In one embodiment, the at least one of the one or more authentication rules may include authentication of at least one of: a primary account number, personal identification number, merchant identifier, and geographic location included in the transaction data values. In some embodiments, the at least one of the one or more verification rules may include verification of at least one of: a sending address, a recipient address, a blockchain address, and a currency amount included in the blockchain data.

### Payment Transaction Processing System and Process

FIG. 7 illustrates a transaction processing system and a process 700 for the processing of payment transactions in the system. The process 700 and steps included therein may be performed by one or more components of the system 100 discussed above, such as the processing server 102, financial institution 104, payment network 106, transaction processing device 108, issuer 110, acquirer 112, etc. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 3-6, discussed above, with respect to the step or steps involved in the processing of a payment transaction. In addition, the entities discussed herein for performing the process 700 may include one or more computing devices or systems configured to perform the functions discussed below. For instance, the merchant 706 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 708 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 702 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution 702. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device specifically configured to perform the functions discussed herein. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for validating blockchain transactions and electronic payment transactions via the use of both private blockchains and payment networks. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for validating blockchain transactions using a transaction processing network, comprising:
storing, in a rules database of a processing server, a plurality of transaction rules including at least one or more authentication rules configured to authenticate an electronic transaction and one or more verification rules configured to verify a blockchain transaction;
receiving, by a receiving device of the processing server, a transaction message, wherein the transaction message is associated with an electronic transaction, is formatted based on one or more standards, and includes at least a message type indicator indicative of a type of transaction and a plurality of data elements including at least one or more first data elements configured to store blockchain data and a plurality of additional data elements configured to store transaction data values;
identifying, by an authentication module of the processing server, an authentication score for the electronic transaction based on application of at least one of the one or more authentication rules to the transaction data values stored in the plurality of additional data elements included in the received transaction message;
identifying, by a verification module of the processing server, a verification score for the electronic transaction based on application of at least one of the one or more verification rules to the blockchain data stored in the one or more first data elements included in the received transaction message;
generating, by a generation module of the processing server, a data message, wherein the data message includes at least the blockchain data stored in the one or more first data elements included in the received transaction message, the identified authentication score, and the identified verification score; and
electronically transmitting, by a transmitting device of the processing server, the generated data message to a blockchain network associated with the blockchain data stored in the one or more first data elements included in the received transaction message.

2. The method of claim 1, wherein the blockchain data includes at least one of: a network identifier, a network address, a sender address, a recipient address, and a currency amount.

3. The method of claim 2, wherein the blockchain network is associated with the network identifier included in the blockchain data.

4. The method of claim 1, wherein the type of transaction is an authorization request.

5. The method of claim 1, wherein the one or more standards includes the ISO 8583 standard.

6. The method of claim 1, wherein the transaction data values include at least one of: transaction amount, transaction time, transaction date, primary account number, merchant identifier, issuer identifier, acquirer identifier, processor identifier, and geographic location.

7. The method of claim 1, wherein
the plurality of additional data elements includes a transaction identifier, and
the generated data message further includes the transaction identifier.

8. The method of claim 1, wherein the generated data message is electronically transmitted via superimposition in an electronically transmitted data signal.

9. The method of claim 1, wherein the at least one of the one or more authentication rules includes authentication of at least one of: a primary account number, personal identification number, merchant identifier, and geographic location included in the transaction data values.

10. The method of claim 1, wherein the at least one of the one or more verification rules includes verification of at least one of: a sending address, a recipient address, a blockchain address, and a currency amount included in the blockchain data.

11. A system for validating blockchain transactions using a transaction processing network, comprising:
a rules database of a processing server configured to store a plurality of transaction rules including at least one or more authentication rules configured to authenticate an electronic transaction and one or more verification rules configured to verify a blockchain transaction;
a receiving device of the processing server configured to receive a transaction message, wherein the transaction message is associated with an electronic transaction, is formatted based on one or more standards, and includes at least a message type indicator indicative of a type of transaction and a plurality of data elements including at least one or more first data elements configured to store blockchain data and a plurality of additional data elements configured to store transaction data values;
an authentication module of the processing server configured to identify an authentication score for the electronic transaction based on application of at least one of the one or more authentication rules to the transaction data values stored in the plurality of additional data elements included in the received transaction message;
a verification module of the processing server configured to identify a verification score for the electronic transaction based on application of at least one of the one or more verification rules to the blockchain data stored in the one or more first data elements included in the received transaction message;
a generation module of the processing server configured to generate a data message, wherein the data message includes at least the blockchain data stored in the one or more first data elements included in the received transaction message, the identified authentication score, and the identified verification score; and
a transmitting device of the processing server configured to electronically transmit the generated data message to a blockchain network associated with the blockchain data stored in the one or more first data elements included in the received transaction message.

12. The system of claim 11, wherein the blockchain data includes at least one of: a network identifier, a network address, a sender address, a recipient address, and a currency amount.

13. The system of claim 12, wherein the blockchain network is associated with the network identifier included in the blockchain data.

14. The system of claim 11, wherein the type of transaction is an authorization request.

15. The system of claim 11, wherein the one or more standards includes the ISO 8583 standard.

16. The system of claim 11, wherein the transaction data values include at least one of: transaction amount, transaction time, transaction date, primary account number, merchant identifier, issuer identifier, acquirer identifier, processor identifier, and geographic location.

17. The system of claim 11, wherein
the plurality of additional data elements includes a transaction identifier, and
the generated data message further includes the transaction identifier.

18. The system of claim 11, wherein the generated data message is electronically transmitted via superimposition in an electronically transmitted data signal.

19. The system of claim 11, wherein the at least one of the one or more authentication rules includes authentication of at least one of: a primary account number, personal identification number, merchant identifier, and geographic location included in the transaction data values.

20. The system of claim 11, wherein the at least one of the one or more verification rules includes verification of at least one of: a sending address, a recipient address, a blockchain address, and a currency amount included in the blockchain data.
